(19) United States
(12) Patent Application Publication
(10) Pub. No.: US 2005/0116795 A1
(43) Pub. Date: Jun. 2, 2005

(54) Microwave ceramic filter with improved coupling and method for the production

(76) Inventors: Bernhard Reichel, Deutschlandsberg (AT); Christian Faistauer, Deutschlandsberg (AT); Alexander Freising, Hart b. Graz (AT)

Correspondence Address: SCHIFF HARDIN LLP;Patent Department, 6600 Sears Tower, 233 South Wacker Drive, Chicago, IL, 60606, US

(21) Appl. No.: 10/808,928

(22) Filed: Mar. 25, 2004

(30) Foreign Application Priority Data
Mar. 25, 2003 (DE) 103 13 336.4

(51) Int. Cl. H01P 1/205

(52) U.S. Cl. 333/202; 333/206

(57) ABSTRACT

In a microwave ceramic filter having a ceramic base body with metallized bores and an exterior metallization that is closed all over with the exception of the end face, metallic structures in the form of metallized recesses in the end face are formed on the non-metallized end face. These can be inserted as coupling structures and decoupling structures. The capacitance can be simply adjusted via the depth of the recesses. The size and the position of the contact surfaces for these coupling structures can be independently created on an exterior surface of the ceramic body.

### BACKGROUND

A known microwave ceramic filter comprises at least one resonator which is formed in a dielectric ceramic base body. For this purpose, the base body has a central bore whose interior walls are metallized. With the exception of an end face, the exterior surface walls of the ceramic base body are also metallized and are contacted with the metallized bore at the short circuit side which is opposite the non-metallized end face. Electrical contact surfaces, which are electrically separated from the exterior metallization, are situated at a lateral face whereby the electrical contact surfaces are configured for a capacitive coupling with respect to the metallized bore and therefore represent coupling structures, whereby the metallized bore represents the actual resonator.

Such a filter, however, has the problem that the adjustment of the filter to the impedance of the circuit environment depends on the capacitance between the contact surfaces at the exterior surface of the base body and the metallization in the resonator bores. The capacitance, in turn, is dependent on the relative arrangement of the resonator bore with respect to the contact surfaces and on its value. Since the component, however, is electrically contacted at the same time via the coupling structures and is soldered onto a board particularly for this purpose, a reciprocal dependency results between the position of the coupling structures on the base body and the geometry of the corresponding contact surfaces on the board. As a result, it is not possible without further ado to modify the position of the coupling structures at the ceramic base body without creating a new design of the entire filter at the same time.

European Patent No 0 809 315 A1 proposes to produce the coupling capacitance not only between the resonator bores and the contact surfaces on the exterior surface but to additionally provide coupling structures on the end face of the base body which is otherwise free of metallizations, so that it is possible to adjust a desired capacitance between the contact surfaces and the resonator bores. These additional coupling structures, which are connected to the contact surfaces in an electrically-conducting manner, are deposited, according to known methods, in the same way as the other metallizations. For example, they are printed-on or burned-in as a silver-containing screen printing paste. It is also possible to deposit these metallizations on the entire surface and to subsequently structure them. Both possibilities, however, are highly involved and therefore extend the time of production and increase the costs for the component.

### SUMMARY OF THE INVENTION

It is an object to propose a microwave ceramic filter which allows an improved coupling and which can be simply manufactured.

In a microwave ceramic filter, a ceramic base body is provided with at least one metallized bore in the base body. A closed exterior metallization arranged on exterior surfaces of the base body is provided, with the exception of one end face. At least one metallic structure on the one end face comprising at least one coupling structure is provided. The at least one metallic structure is formed as at least one metallized recess in the one end face.

In a method for producing a microwave ceramic filter having at least one metallic structure on an end face, a ceramic green body is produced with at least one through bore and at least one recess at an end face of the green body. The green body is sintered to form a ceramic base body. The base body is metallized wherein an exterior metallization is generated on surfaces including an interior surface of the recess and an interior surface of the bore. The exterior metallization is mechanically removed on the end face such that the metallization in the recess remains to create said metallic structure on the end face.

### BRIEF DESCRIPTION OF THE DRAWINGS

FIG. 1 shows a filter in a spatial representation;

FIG. 1A shows a section of FIG. 1; and

FIGS. 2 to 5, in a schematic plan view onto the end face, show different arrangements of coupling structures, decoupling structures and resonators.

### DESCRIPTION OF THE PREFERRED EMBODIMENTS

For the purposes of promoting an understanding of the principles of the invention, reference will now be made to the preferred embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

In the same way as known filters, the microwave ceramic filter of the preferred embodiment is comprised of a ceramic base body having a metallized bore. The exterior surfaces of the base body have a closed exterior metallization whereby an end face is free of metallization. As known from the prior art, the end face has metallic structures which are designed as coupling structures or which have the coupling structures given the disclosed filter. Given the filter of the preferred embodiments, the metallic structures, however, are formed as metallized recesses in the end face. In contrast to the known metallic structures, which are deposited onto the end face in a plane manner, the metallic structures have a three-dimensional structure. The three-dimensional structure makes it possible to adjust a desired capacitance in a simpler way with the assistance of the additional degree of freedom.

On the basis of a chamfer (groove-shaped recess), which is formed at the front and/or back edge of the upper end face, the advantage results that an optically controllable soldering meniscus arises during the mounting or soldering of the filter onto a board. The chamfer also has the advantage that it can serve the purpose of adjusting the filter characteristic and particularly the bandwidth of the microwave ceramic filter.

The disclosed embodiment also makes it possible to increase the width of variation of the possible adjustable capacitances. This has the further advantage that the value of the coupling capacitance is even more independent of the value and arrangement of the electrical contact surfaces on the exterior surface of the base body, whereby the electrical contact surfaces, as given known filters, are arranged at an exterior face of the ceramic base body in an electrically isolated manner relative to the exterior metallization. The metallic structures are connected to the cited contact surfaces in an electrically-conducting manner when the metallic structures are designed as a coupling capacitance. The value of the capacitance is predominately determined by the depth and arrangement of the metallic structures. This allows additional degrees of freedom regarding the value and arrangement of the contact surfaces without the electrical values of the filter being inadmissibly modified by such a variation of the contact surfaces. Therefore, it is possible to adjust a filter, in a simple manner, to an arbitrary circuit environment into which it can be soldered. The position of the electrical contact surfaces can almost be selected arbitrarily, or at least can be varied to a great extent.

A filter response arises if two resonators are suitably coupled. Therefore, at least two resonator bores are necessary for adjusting desired specifications. Metallic structures designed as coupling structures form a capacitance with respect to one or more resonator bores. This means that metallic structures used as coupling structures are close to a resonator bore but at a defined distance and electrically separated from it.

A filter, however, can also be configured as a duplexer having two sub-filters which are connected to a common antenna terminal. A duplexer is used in terminal devices of the mobile communication and guides a signal received via the antenna into the corresponding Rx filter which, at the output side, is connected to the Rx path of the component in which the received signal is further processed, for example amplified or filtered again. Electrical signals generated in the Tx path of the component, which is configured as a duplexer, are led to the antenna via the corresponding output filter, the Tx filter. The duplexer assures that the paths do not mutually influence one another and that, for example, a Tx signal does not couple into the Rx path.

A filter configured as a duplexer has at least three coupling structures which are formed as metallizations that are sunken into the end face or are formed as metallized recesses on the end face. Respectively one of the coupling structures is connected to the corresponding contact surfaces for the Rx path, the antenna terminal or the Tx path in an electrically conducting manner. The metallic structures form coupling capacitances with respect to the resonator bores.

In addition to the coupling capacitances, additional metallic structures for decoupling the two sub-filters (Tx filter or Rx filter) can be provided in a configured duplexer. In the same way as the cited coupling structures, these metallic decoupling structures are also formed as metallized recesses in the end face. The metallic structures required for the decoupling can be electrically isolated or can be connected to the metallized bores (resonator bores) of a sub-filter. The decoupling structures influence the self-impedance of a filter so that the phase position can be modified in a suitable way. This occurs, in a special case, in the Smith chart, whereby it is attempted to rotate Rx filters and Tx filters with respect to an open circuit whereby this corresponds to a decoupling of the two paths. Therefore, it can be achieved by an appropriate selection of the input impedances that the input impedances of the Rx path and the Tx path no longer influence one another. This corresponds to a rotation in the Smith chart and serves the purpose of decoupling Rx filters and Tx filters so that these are not mutually influenced by their signals. Decoupling structures can be attached to both sub-filters.

While the resonator bore of a filter normally extends via the entire height of the base body, the recess for the metallic structures only reaches a depth representing approximately 1 to 20% of the overall height of the base body. Therefore, a front-end filter, which is designed for frequencies in the GHz range as used in the mobile radio telephone service, has metallized recesses having a depth of 0.1 to 1 mm in the end face. Given the filters, the depth of the recesses in the end face representing the spatial dimension of the coupling capacitance can be simply used for adjusting the value of the coupling capacitances. A higher capacitance can be adjusted by a greater depth of the recesses. Given an otherwise equal surface need regarding the end face, a metallization (metallic structure), which is arranged in recesses, has a correspondingly higher capacitance or forms a correspondingly higher capacitance with respect to the resonator bores.

A filter has the further advantage that metallic structures, which are formed in recesses on the end face, can be produced in a simpler way compared to the planar, surface-deposited metallizations known from the prior art.

The following method steps are carried out in a method of the preferred embodiment for producing a microwave ceramic filter having metallic structures on an end face:
producing a ceramic base body having a through bore and at least one recess on an end face of the base body having the bore by sintering a green body which then becomes a ceramic base body;
metalizing the base body, whereby an exterior metallization is generated on all surfaces including the recess and an interior metallization is generated in the bore; and
mechanically removing the exterior metallization on the end face, whereby the metallization remains as a metallic structure in the recess.

In contrast to the production of known microwave ceramic filters, the method of the preferred embodiment does not require an additional step for producing and structuring the metallic structures. The only modification is that the base body is generated with additional recesses. This, however, occurs in an integrated manner and does not require an additional step. For example, what is known as a “green” body, with a press tool, is produced from a ceramic powder mass which is treated or mixed with a binder. On the basis of a corresponding forming of the press tool, the recess can also be generated in a simple manner during the pressing and production of the green body.

Simultaneously, a chamfer at the front edge and/or the back edge of the upper end face can also be produced during the pressing of the green body.

The exterior metallization can be produced in an arbitrary manner and in a way that is known per se. It is advantageous, for example, to generate the exterior metallization in a galvanic or electrochemical manner. For this purpose, it can be advantageous to initially deposit a base metallization onto the ceramic, for example by chemically separating a suitable metal.

As is the case with respect to known filters, the exterior metallization on the end face must also be removed given the provided filter. The recess now assures that the metallization deposited therein remains on the end face and the metallization on the locations of the end face, which are not recessed, is removed. In a simple way, the exterior metallization on the end face can be removed by abrading or polishing.

The electrical splitting between the exterior metallization and the contact surfaces for the capacitive coupling can occur, as is known, for example mechanically.

The electrical connection of the metallic structure on the end face with respect to the exterior metallization or the contact surfaces can occur in a simple way by suitably positioning the recess. The recess is directly led up to the edge between the end face and the exterior surface provided for the contact or connection, so that the cited edge is situated in the recess. It is thus assured that a direct electrical contact remains between the metallization in the recess and the exterior metallization or the later contact surfaces given abrading of the end face.

The preferred embodiment is shown in detail in the corresponding drawing figures. The drawings show different exemplary embodiments of the invention on the basis of schematic representations that are not scaled. The same elements or elements having the same effect are provided with the same reference characters.

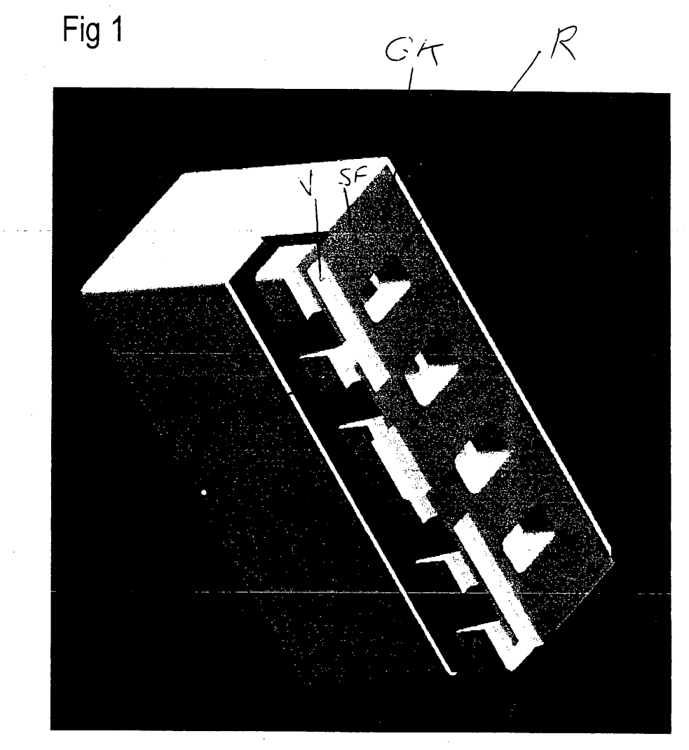

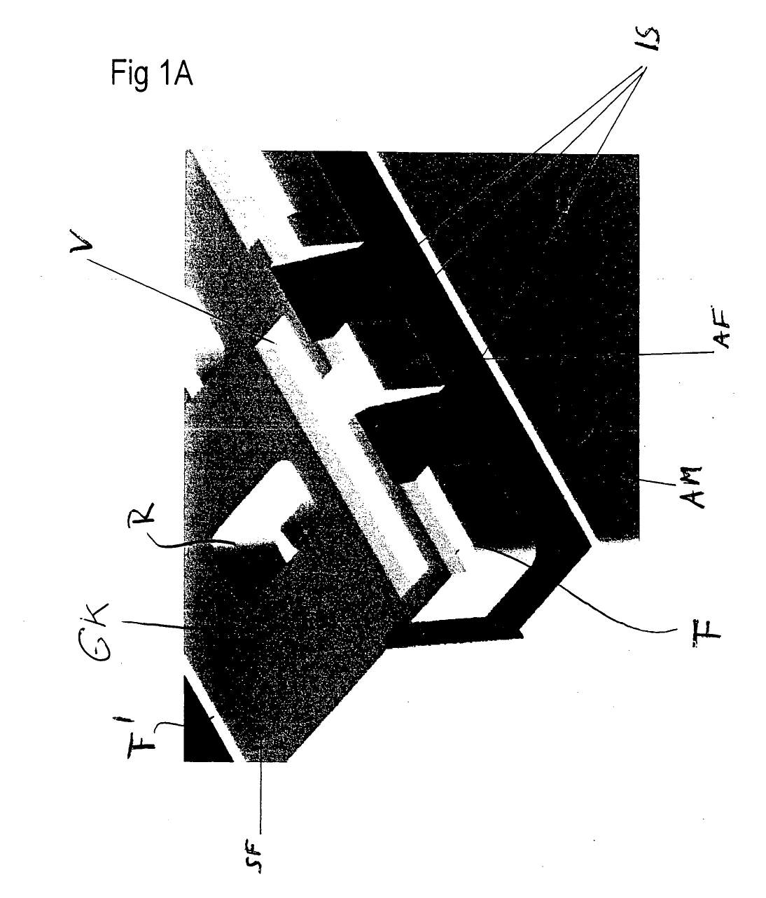

FIG. 1 three-dimensionally shows a preferred embodiment of the microwave ceramic filter. Said microwave ceramic filter is comprised of a dielectric, ceramic base body GK. Resonator bores R are arranged approximately parallel to one another in the ceramic base body such that they connect the two end faces SF to one another. The longitudinal section of the resonator bores can be arbitrarily selected, for example circular or rectangular. Given the preferred embodiment, the resonator bores R preferably have a cross section that changes in a stepwise manner. The cross section is circular, for example, in the lower region and is rectangular, for example, in the upper region. As a result, an impedance jump is generated that further improves the characteristic of the filter. Preferably, the center axes of the circular and rectangular cross section are not congruent but are offset to one another so that further advantages result with respect to the filtering properties. The lower part of the resonator bore, in particular, is partially covered or undercut by the offset of the upper bore section.

With the exception of the shown end face SF, an exterior metallization AM is deposited onto all exterior surfaces. The resonator bores R are also metallized in the inside but are not filled with metal. Recesses V having metallized interior surfaces are arranged on the end face SF. Electrical contact surfaces AF are provided on the front side of the base body GK facing the viewer, whereby said electrical contact surfaces are electrically separated from the exterior metallization with the assistance of an insulating strip IS in which the exterior metallization has been removed. The contact surfaces AF are electrically connected to the metallization in the recesses V.

FIG. 1A, in an enlarged representation, shows such a recess V in the end face SF of the ceramic base body GK. In FIG. 1, the metallic structure in the end face is designed as a capacitive coupling structure AK whose metallization forms a capacitance with respect to the resonator (left in the Figure) or to the metallization in the left resonator bore R. As shown, the insulating strips, which, for example, are generated by grinding or have the exterior metallization removed, partially can be grinded-in in a beveling manner. The filter is contacted via the two contact surfaces AF. For this purpose, the filter is suitably arranged on a board with its contact surfaces AF. A chamfer F, which is metallized “inside”, i.e. on all surfaces situated below the end face, is provided at the front and back edge of the upper end face SF.

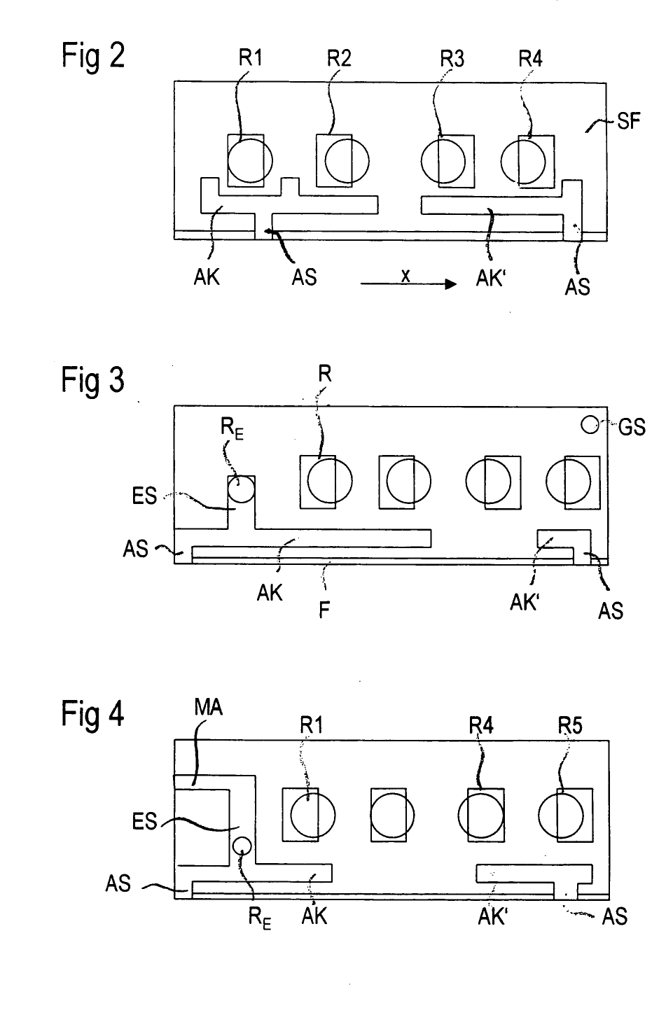

In a schematic plan view onto the end face, FIG. 2 shows a further possible arrangement of coupling structures and resonator bores R. This filter also has two contact surfaces AF (not shown in the Figure) which are connected to the coupling structures AK via contact elements AS. In the Figure, each of the two coupling structures AK, AK′ forms one capacitance with respect to two resonators or the metallization in two resonator bores R. It becomes clear from the drawing figure that the capacitance of the coupling structures AK essentially is determined by their positioning relative to the resonator bores R. This means that the contact elements As, with respect to their position on the x-axis, are uncritical for the height of the coupling capacitance and therefore can be approximately freely displaced on the x-axis, whereby the contact elements As connect the coupling structures AK to the contact surfaces on the front side of the base body. As a result, the contact surfaces on the front side (not shown) can also be displaced along the x-axis and can be adapted to the respective board layout.

The drawing figure also shows the offset of the two different sections of each resonator bore, whereby the lower section can be offset to the upper section such that it is partially covered, for example (as shown). The different resonator bores can be arranged in series or can also be offset to one another, depending on the application.

FIG. 3 shows a further embodiment. An additional decoupling structure ES is shown in addition to the coupling structures AK and AK′ effecting a capacitive coupling of resonator bores R with respect to the contact surfaces AF (not shown). The decoupling structure is electrically connected to the coupling structure AK and to the interior metallization of a resonator bore RE. This can be advantageous for adjusting the filter to a given circuit environment with respect to the impedance. A counter-oscillator GS representing a weakly coupling resonator is also shown as a further detail. The phase position and input impedance of the filter can be advantageously influenced by appropriately selecting the coupling structures AK, the position, the diameter and the length of the resonator bore RE. The resonator bore RE can serve the purpose of providing a pole in the transmission curve of the filter—at which the filter exhibits a particularly advantageous attenuation.

FIG. 4 shows another exemplary embodiment; it also has a decoupling structure ES (similar to FIG. 3) which is connected to the coupling structure AK and to a resonator bore RE. The decoupling structure ES additionally has a ground connection MA which connects the decoupling structure ES to the exterior metallization AM that is connected to the ground. A first coupling structure AK is capacitively coupled to the first resonator bore R1. A second coupling structure AK′ is capacitively coupled to the resonator bores R4 and R5. The contact elements AS connect the coupling structures AK to contact surfaces (not shown in the Figure) on the exterior faces of the base body.

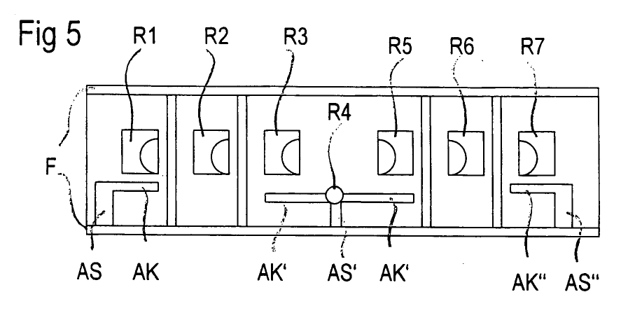

In a schematic plan view onto the end face of a further exemplary embodiment, FIG. 5 shows the arrangement of coupling structures, decoupling structures and resonator bores of a duplexer. The duplexer has three contact surfaces (not shown) which are connected to corresponding coupling structures AK, AK′ and AK″ via contact elements AS, AS′ and AS″. A first coupling structure is capacitively coupled to a first resonator bore RI. A second coupling structure AK′ is capacitively coupled to the resonator bores R3 and R5. The resonator bore R4, via a decoupling structure, is electrically connected to the coupling structure AK′ and is decoupled as a result. A third coupling structure AK″ is capacitively coupled to the resonator bore R7. Further metallic structures, which are formed as metallizations in a recess, are close to, but at a distance from, resonator bores R2 and R6. These metallic structures are connected to the exterior metallization via corresponding contact elements. They capacitively decouple the resonator bores R2 and R6.

Initially, a ceramic base body is produced given the method for producing a microwave ceramic filter. For this purpose, a ceramic having a suitable dielectric constant is ground or pulverized to a powder and is plasticized with a binder to form what is known as a “green body”. The shaping of this green body occurs in a press whereby the exterior form of the green body is generated and the resonator bores R, as well as the recesses V, are simultaneously pressed into the-green body.

Subsequently, the green body is sintered whereby the binder is thoroughly burned off and the resulting ceramic structure is compressed and strengthened to form the base body GK. The base body GK formed in this way is subsequently metallized at all uncovered surfaces.

A suitable minimum coating thickness for the metallization is 5-20 μm, for example. A coating thickness that is too high is avoided since it is disadvantageous concerning the component properties. Subsequently, the exterior metallization AM is mechanically abraded in the area of the end face SF whereby the metallization remains in the recesses.

In a further step, the contact surfaces AF are electrically separated from the other exterior metallization on the front side, whereby this can also be mechanically carried out, for example, by a grinding wheel which is hard-faced with abrasive material. The grinding wheel is guided via the surface The a suitable way so that an insulating strip IS arises and the contact surfaces AF are electrically insulated from the exterior metallization AM. After this method step, an operative filter has been manufactured. The what are referred to as λ/4 resonators formed in the bores by the metallization are in an open circuit on the end face but are short-circuited with the exterior metallization on the opposite end face (not shown in FIG. 1). The resonator frequency of the resonators can be simply adjusted via the length of the resonator bores or via the height of the ceramic base body.

In another exemplary embodiment, the filters can be further modified in a way known per se, for example by designing the resonator bores with a non-rectilinear through bore. It is also possible to form the resonator bores such that they have different cross-sectional surfaces or cross-sectional forms in different sections. It is also possible to generate a discontinuity in the ceramic base body and to produce the base body from two ceramic sub-bodies given a base body that is laterally divided with respect to the resonator bores. The sub-bodies are produced on the basis of two ceramic materials having a different dielectric constant.

Although the exemplary embodiments only describe a limited number of possible structures on the end face of the filters, the filter is not limited to these structures. It is possible to produce coupling structures, decoupling structures and further metallic structures on the surface in an arbitrary number and shaping in order to modify the properties of the filter as desired. The filter is also not limited to the cited materials, the number of represented bores or to specific frequencies.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

1. A microwave ceramic filter, comprising:
a ceramic base body;
at least one metallized bore in the base body;
a closed exterior metallization arranged on exterior surfaces of the base body with the exception of one end face;
at least one metallic structure on the one end face comprising at least one coupling structure; and
the at least one metallic structure being formed as at least one metallized recess in the one end face.

2. A filter according to claim 1 wherein the at least one metallic structure is connected to a contact surface on an exterior face representing a bottom side, said contact surface being electrically insulated with respect to the exterior metallization.

3. A filter according to claim 1 wherein at least two of the metallized bores for two sub-filters of a duplexer are provided and at least three metallic structures are formed as coupling structures.

4. A filter according to claim 3 wherein at least one further metallic structure is provided on the one end face for decoupling the two sub-filters of the duplexer.

5. A filter according to claim 1 wherein the at least one recess has a depth between 1 and 20% of an overall height of the base body.

6. A filter according to claim 1 wherein the at least one recess has a depth of 0.1 up to 1 mm.

7. A filter according to claim 1 wherein a capacitive coupling with respect to the metallized bore is adjusted via a depth of the at least one metallic structure.

8. A filter according to claim 4 wherein the at least one further metallic structure formed for the decoupling is electrically connected to at least one metallized bore.

9. A method for producing a microwave ceramic filter having at least one metallic structure on an end face, comprising the steps of:
producing a ceramic green body with at least one through bore and at least one recess on an end face of the green body;
sintering the green body to form a ceramic base body;
metalizing the base body, wherein an exterior metallization is generated on surfaces including an interior surface of the recess and an interior surface of the bore; and
mechanically removing the exterior metallization on said end face such that the metallization in the recess remains to create said structure on the end face.

10. A method according to claim 9 wherein the ceramic green body is formed by pressing a ceramic powder which is treated with a binder to shape it with the assistance of a press tool, wherein a generation of the bore and the recess occurs at a same time as the shaping of the green body as a result of a corresponding forming of the press tool.

11. A method according to claims 9 wherein the metallization at the end face of the base body is roughened.

12. A method according to claims 9 wherein surface areas of the exterior metallization are provided as at least one electrical contact surface electrically separated from the exterior surface provided as a bottom side, wherein the contact surface is connected to the metallic structure provided as a coupling structure on the end face in an electrically conducting manner.

13. A microwave ceramic filter, comprising:
a ceramic base body;
a plurality of metallized bores in an end face of the base body;
an exterior metallization arranged on exterior surfaces of the base body but not on the one end face;
a plurality of metallic structures on the one end face comprising coupling structures; and
the metallic structure being formed as metallized recesses of the one end face.

14. A method for producing a microwave ceramic filter having metallic structures on an end face, comprising the steps of:
producing a ceramic body by pressing a ceramic powder with a binder and providing a through bore and a plurality of recesses on an end face of the green body;
sintering the green body to form a ceramic base body;
metalizing the base body, wherein an exterior metallization is generated on surfaces including interior surfaces of the recesses and interior surfaces of the bores; and
removing the exterior metallization on said end face such that the metallization in the recesses remain to create said metallic structures.
